(19) United States
(12) Patent Application Publication
(10) Pub. No.: US 2012/0052587 A1
(43) Pub. Date: Mar. 1, 2012

(54) Colorimetric Method for Detection of Biodiesel in Fuel

(76) Inventors: Geoffrey T. Eldridge, California, MD (US); Thomas J. Jalinsk, Leonardtown, MD (US)

(21) Appl. No.: 12/868,772

(22) Filed: Aug. 26, 2010

(51) Int. Cl. G01N 21/01; G01N 21/00

(52) U.S. Cl. 436/128; 422/82.05

(57) ABSTRACT

The method of detection of biodiesel (FAMEs) in fuel includes the following steps: placing test fuel in a container, adding a 0.5 N solution of hydroxylamine in ethanol to the container, adding 20% sodium hydroxide solution to the container, heating the test fuel, the 0.5 N solution of hydroxylamine in ethanol, and the 20% sodium hydroxide solution in the container such that the test fuel, the 0.5 N solution of hydroxylamine in ethanol, and the 20% sodium hydroxide solution is boiling, adding 1 N hydrochloric acid to the container, adding 10% iron (III) chloride solution to the container, such that violet or pink appears in the container when there is biodiesel in the fuel.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a method of detection of biodiesel in fuel. More specifically, but without limitation, the present invention relates to a colorimetric method of detection of biodiesel in fuel.

Biodiesels are defined as fuels that have monoalkyl esters of various fatty acids. Biodiesels are commonly referred to as fatty acid methyl esters or FAMEs. Biodiesel is often blended with commercial fuel, particularly with regular diesel. The blending level affects engine performance, and use of commercial fuel with biodiesel has caused damage in engines of various U.S. military vessels. Therefore, there is a need for a field test in order to determine if there is biodiesel in fuel.

The current state of the art methods for detection of biodiesel or FAMEs in fuel focus on instrumental methods. The instrumentation used is expensive, requires extensive user training, is not rapidly deployable, and is unlikely to be certified aboard a military ship.

### SUMMARY

The present invention is directed to a method of detection of biodiesel (FAMEs) in fuel that meets the needs enumerated above and below.

The present invention is directed to the method of detection of biodiesel (FAMEs) in fuel, which includes the following steps: placing test fuel in a container, adding a 0.5 N solution of hydroxylamine in ethanol to the container, adding 20% sodium hydroxide solution to the container, heating the test fuel, the 0.5 N solution of hydroxylamine in ethanol, and the 20% sodium hydroxide solution in the container such that the test fuel, the 0.5 N solution of hydroxylamine in ethanol, and the 20% sodium hydroxide solution is boiling, adding 1 N hydrochloric acid to the container, adding 10% iron (III) chloride solution to the container, such that violet or pink appears in the container when there is biodiesel in the fuel.

It is a feature of the present invention to provide a method of detection of biodiesel in fuel that is inexpensive and immediately usable by a user.

It is a feature of the present invention to provide a method of detection of biodiesel that can be performed easily without extensive training

It is a feature of the present invention to provide a method of detection of biodiesel that does not require an expensive initial investment in instrumentation or any of the costs associated with maintaining chemical instrumentation.

### DRAWINGS

These and other features, aspects and advantages of the present invention will become better understood with reference to the following description and appended claims, and accompanying drawings wherein:

FIG. 1 is a flow chart describing one of the preferred embodiments of the colorimetric method for detection of biodiesel in fuel; and,

FIG. 2 is one of the embodiments for the kit for detecting biodiesel in fuel.

### DESCRIPTION

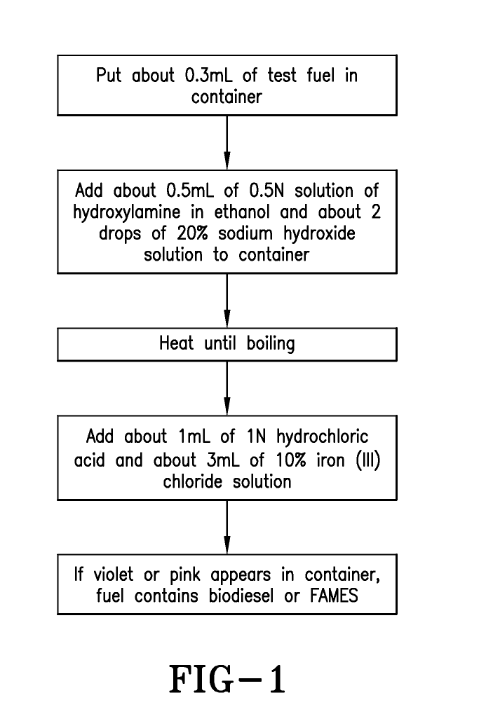

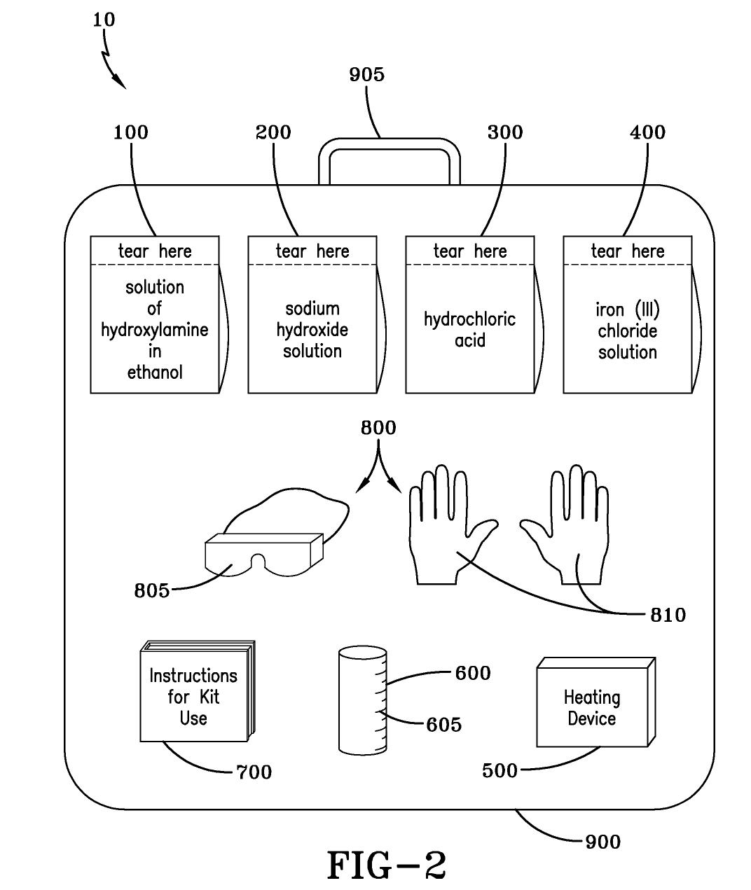

The preferred embodiments of the present invention are illustrated by way of example below and in FIGS. 1-2. As shown in FIG. 1, the method of detection of biodiesel (FAMEs) in fuel includes the following steps: placing test fuel in a container, adding a 0.5 N solution of hydroxylamine in ethanol to the container, adding 20% sodium hydroxide solution to the container, heating the test fuel, the 0.5 N solution of hydroxylamine in ethanol, and the 20% sodium hydroxide solution in the container such that the test fuel, the 0.5 N solution of hydroxylamine in ethanol, and the 20% sodium hydroxide solution is boiling, adding 1 N hydrochloric acid to the container, adding 10% iron (III) chloride solution to the container, such that violet or pink appears in the container when there is biodiesel in the fuel.

In the description of the present invention, the invention will be discussed in a military environment particularly when utilizing diesel fuel; however, this invention can be utilized for any type of application that requires a user to detect biodiesel in fuel.

The container may be a beaker, test tube or any type of vessel for holding liquids and/or solutions. Preferably, the container is clear and graduated with markings that show measurements. In the preferred embodiment, for use in clear and bright F-76 diesel fuel, about 0.3 mL of fuel (the test fuel) taken from the fuel to be tested is placed in the container. Then about 0.5 ml of 0.5 N solution of hydroxylamine in ethanol is added to the container. The term N is defined as normal solution, which may be defined, but without limitation, as a solution that contains one equivalent of the active reagent in grams, in one liter of the solution. Then about 2 drops of 20% sodium hydroxide solution is added to the container. The fuel and the two reagents are then heated to boiling. The preferred method of heating is a water bath or any type of non-flame method of heating. Examples of non-flame methods of heating include, but without limitation, use of electricity, induction, and electronic resistance heating by direct contact or radiation. After heating them to a boil, about 1 mL of 1 N hydrochloric acid and about 3 mL of 10% iron (III) chloride solution is added to the container. A violet or pink color is a positive test for the presence of biodiesel or FAMEs. High concentrations of FAMES in fuel produce tests with dark violet colors throughout the container. Low concentrations of FAMEs produce tests with a light pink ring on top of the aqueous layer. The preferred method described has a detection limit for biodiesels of FAMEs of approximately 0.5% by volume, which is sufficient to provide protection from acute engine/fuel system damage from biodiesel/FAME contaminated fuel. However, the test fuel and reagents amounts may be used in a similar ratio as described, or various other ratios depending on desired results or type of fuel being tested.

Other embodiments of the invention may include other types of metal other than iron (in the 10% iron (III) chloride solution). The types of metal that can be utilized are any type that can be used to induce a color change that is detectable.

The method may be utilized in a kit. The kit 10, as shown in FIG. 2, can include 0.5 N solution of hydroxylamine in ethanol 100, 20% sodium hydroxide solution 200, 1 N hydrochloric acid 300, 10% iron (III) chloride solution 400, a heating device 500 and a container 600. As shown in FIG. 2 the four reagents (100, 200, 300 and 400) may be premeasured (in amounts previously described or in other premeasured amounts) and placed in tear-open packages. The container 600 may include measurement markings 605 such that a predetermined amount of fuel can be placed in the container 600. The kit 10 may also include instructions 700 on use, as well as, protective gear 800 such as, but without limitation, as safety goggles 805 and gloves 810. The kit may be placed in a kit container 900 such that all the elements of the kit 10 can be safely secured and stored. The elements of the kit 10 may be stored in the kit container 900 in any means practicable. Additionally, the kit container 900 may include a handle 905 such that the kit 10 can be easily transported.

If the fuel contains a dye, the dye may be removed from the fuel prior to utilizing the method described herein. Alternatively, a colorimeter may be used to compare the color of the untested dyed fuel, to a fuel which has been tested in accordance with the procedure outlined above.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method of detection of biodiesel (FAMEs) in fuel, comprising:
placing test fuel in a container;
adding a 0.5 N solution of hydroxylamine in ethanol to the container;
adding a 20% sodium hydroxide solution to the container;
heating the test fuel, the 0.5 N solution of hydroxylamine in ethanol, and the 20% sodium hydroxide solution in the container such that the test fuel, the 0.5 N solution of hydroxylamine in ethanol, and the 20% sodium hydroxide solution is boiling;
adding 1 N hydrochloric acid to the container;
adding 10% iron (III) chloride solution to the container, such that violet or pink appears in the container when there is biodiesel in the fuel.

2. The method of claim 1, wherein 0.3 mL of test fuel is placed in the container.

3. The method of claim 2, wherein 0.5 mL of 0.5 N solution of hydroxylamine in ethanol to the container is added.

4. The method of claim 3 wherein, 2 drops of 20% sodium hydrochloride solution is added.

5. The method of claim 4 wherein 1 mL of 1 N hydrochloric acid is added.

6. The method of claim 5 wherein 3 mL of 10% iron (III) chloride solution is added.

7. The method of claim 6 wherein the test fuel, 0.5 N solution of hydroxylamine in ethanol, and 20% sodium hydroxide solution are heated to boiling using a water bath.

8. The method of claim 6 wherein the test fuel, 0.5 N solution of hydroxylamine in ethanol, and 20% sodium hydroxide solution are heated to boiling using a non-flame method.

9. A kit for detecting biodiesel in fuel comprising:
a 0.5 N solution of hydroxylamine in ethanol;
a 20% sodium hydroxide solution;
1 N hydrochloric acid;
a 10% iron (III) chloride solution;
a container for combining the fuel sample, the 0.5 N solution of hydroxylamine in ethanol and the 20% sodium hydroxide solution; and,
a heating device for heating the container with the fuel sample, the 0.5 N solution of hydroxylamine in ethanol and the 20% sodium hydroxide solution, such that the fuel sample, the 0.5 N solution of hydroxylamine in ethanol and the 20% sodium hydroxide solution are boiled, wherein the presence of pink or violet in the container when the 1 N hydrochloric acid and the 10% iron (III) chloride solution are combined with the boiled fuel sample, 0.5 N solution of hydroxylamine in ethanol and 20% sodium hydroxide solution, indicates biodiesel in the fuel sample.

10. The kit of claim 9, wherein 0.3 mL of test fuel is placed in the container.

11. The kit of claim 10, wherein there is 0.5 mL of 0.5 N solution of hydroxylamine in ethanol.

12. The kit of claim 11, wherein there are 2 drops of 20% sodium hydrochloride solution.

13. The kit of claim 12 wherein there is 1 mL of 1 N hydrochloric acid.

14. The kit of claim 13 wherein there is 3 mL of 10% iron (III) chloride solution.

15. The kit of claim 14 wherein the heating device is a hand warmer.
